(19) United States
(12) Patent Application Publication
(10) Pub. No.: US 2021/0155001 A1
(43) Pub. Date: May 27, 2021

(54) INKJET RECORDING APPARATUS FOR RECORDING IMAGES BY EJECTING INK ON RECORDING MEDIA

(71) Applicant: KYOCERA Document Solutions Inc., Osaka (JP)

(72) Inventors: Hiroshi YAMASHITA, Osaka (JP); Masanori OKADA, Osaka (JP)

(73) Assignee: KYOCERA Document Solutions Inc., Osaka (JP)

(21) Appl. No.: 17/105,231

(22) Filed: Nov. 25, 2020

(30) Foreign Application Priority Data
Nov. 25, 2019 (JP) 2019-212473

(51) Int. Cl. B41J 2/165; B41J 2/17

(52) U.S. Cl. CPC B41J 2/16532; B41J 2/1707; B41J 2/16523

(57) ABSTRACT

Provided is an inkjet recording apparatus that causes a recording head to execute appropriate flushing based on the presence or absence of a non-ejecting nozzle in order to reduce deterioration of the image quality of recorded images or to improve the ejection failure of a non-ejecting nozzle at an early stage. When the recording head executes a first flushing, a control unit of the inkjet recording apparatus determines the presence or absence of a non-ejecting nozzle based on a detection result of an ejection detection unit. Then, based on the determination result, the control unit selects whether or not to perform a second flushing. In the second flushing, the recording head is caused to eject ink at timing at which a recording medium on the conveyor belt faces the recording head due to traveling of the conveyor belt.

### INCORPORATION BY REFERENCE

This application is based on and claims the benefit of priority from Japanese Patent Application No. 2019-212473 filed on Nov. 25, 2019, the contents of which are hereby incorporated by reference.

### BACKGROUND

The present disclosure is related to an inkjet recording apparatus for recording an image by ejecting ink on a recording medium.

Conventionally, in an inkjet recording apparatus such as an inkjet printer, in order to reduce or prevent clogging of the nozzles due to drying of the ink, flushing for discharging ink from the nozzles (empty discharge) is performed periodically. For example, in the inkjet recording apparatus of a typical technique, opening portions are provided in a conveyor belt, and ink that is not used for image formation is ejected from the nozzles and passed through the opening portions to perform flushing.

### SUMMARY

In order to achieve the object described above, the inkjet recording apparatus according to one aspect of the present disclosure includes a recording head, a control unit, a continuous conveyor belt, and an ejection detection unit. The recording head has a plurality of nozzles that eject ink. The control unit causes the recording head to execute flushing for ejecting the ink at timing different from timing that contributes to image formation on a recording medium. The continuous conveyor belt has a plurality of opening portions through which the ink ejected from each nozzle of the recording head passes, and conveys the recording medium to a position facing the recording head. The ejection detection unit detects the presence or absence of ejection of the ink from each of the nozzles. The flushing includes a first flushing and a second flushing. In the first flushing, the recording head is caused to eject the ink at a timing at which an opening portion faces the recording head due to traveling of the conveyor belt. In the second flushing, the recording head is caused to eject the ink at a timing at which the recording medium on the conveyor belt faces the recording head due to traveling of the conveyor belt. The control unit, when causing the recording head to execute the first flushing, determines the presence or absence of a non-ejecting nozzle in which ink is not ejected based on a detection result of the ejection detection unit. Then, the control unit, based on the determination result of the presence or absence of a non-ejecting nozzle, selects whether or not to perform the second flushing as subsequent flushing, and causes the recording head to execute flushing.

### BRIEF DESCRIPTION OF THE DRAWINGS

FIG. 1 is an explanatory diagram illustrating a schematic configuration of a printer as an inkjet recording apparatus according to an embodiment of the present disclosure.

FIG. 2 is a plan view of a recording unit included in the printer.

FIG. 3 is an explanatory diagram schematically illustrating the configuration around the paper conveying path from the paper feed cassette of the printer to a second conveying unit via a first conveying unit.

FIG. 4 is a block diagram illustrating a hardware configuration of a main part of the printer.

FIG. 5 is explanatory diagram schematically illustrating an area in the first conveying unit where suction force differs.

FIG. 6 is an explanatory diagram schematically illustrating a configuration example of the first conveying unit.

FIG. 7 is an explanatory diagram schematically illustrating another configuration example of the first conveying unit.

FIG. 8 is a plan view illustrating a configuration example of a first conveyor belt of the first conveying unit.

FIG. 9 is an explanatory diagram schematically illustrating an example of a pattern of an opening portion group for flushing when the first conveyor belt of FIG. 8 is used, and illustrates paper arranged on the first conveyor belt according to the pattern.

FIG. 10 is an explanatory diagram schematically illustrating another example of the pattern and paper arranged on the first conveyor belt according to the pattern.

FIG. 11 is an explanatory diagram schematically illustrating yet another example of the pattern and paper arranged on the first conveyor belt according to the pattern.

FIG. 12 is an explanatory diagram schematically illustrating yet another example of the pattern and paper arranged on the first conveyor belt according to the pattern.

FIG. 13 is a plan view illustrating another configuration example of the first conveyor belt.

FIG. 14 is an explanatory diagram schematically illustrating an example of the pattern when the first conveyor belt of FIG. 13 is used and paper arranged on the first conveyor belt according to the pattern.

FIG. 15 is an explanatory diagram schematically illustrating another example of the pattern and paper arranged on the first conveyor belt according to the pattern.

FIG. 16 is an explanatory diagram schematically illustrating yet another example of the pattern and paper arranged on the first conveyor belt according to the pattern.

FIG. 17 is an explanatory diagram schematically illustrating yet another example of the pattern and paper arranged on the first conveyor belt according to the pattern.

FIG. 18 is a flowchart illustrating the flow of processing by flushing control in the printer.

### DETAILED DESCRIPTION

### [1. Configuration of an Inkjet Recording Apparatus]

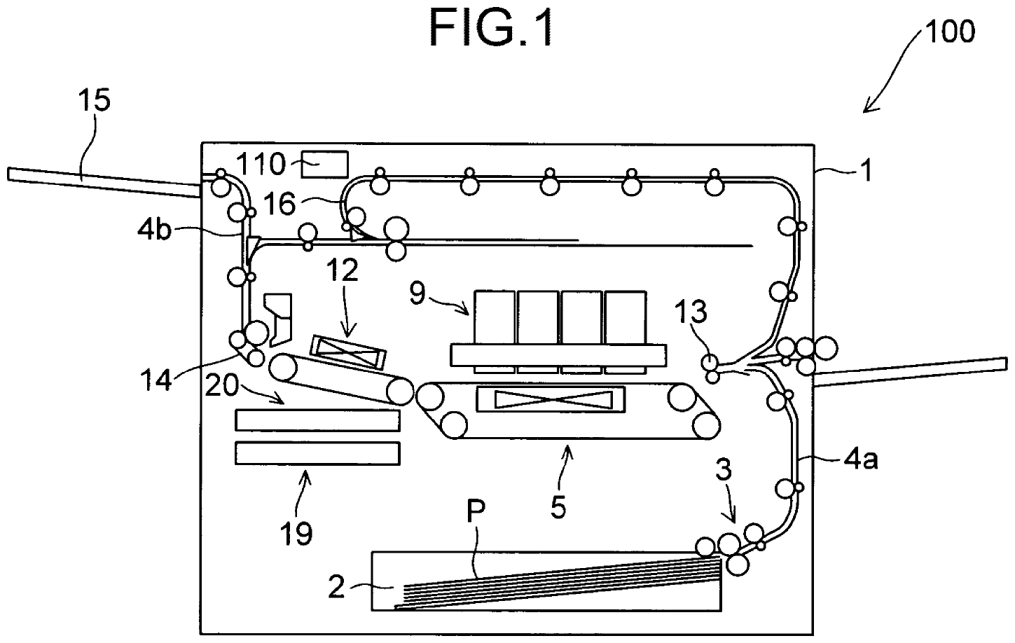

Hereinafter, embodiments of the present disclosure will be described with reference to the drawings. FIG. 1 is an explanatory diagram illustrating a schematic configuration of a printer 100 as an inkjet recording apparatus according to an embodiment of the present disclosure. The printer 100 includes a paper feed cassette 2 that is a paper storage unit. The paper feed cassette 2 is arranged at the lower inner portion of the printer body 1. Paper P, which is an example of a recording medium, is housed inside the paper feed cassette 2.

A paper feeding device 3 is arranged on the downstream side in the paper conveying direction of the paper feed cassette 2, tor in other words, above the right side of the paper feed cassette 2 in FIG. 1. By this paper feeding device 3, paper P is directed toward the upper right of the paper feed cassette 2 in FIG. 1, and is separated and fed out one sheet at a time.

The printer 100 includes a first paper conveying path 4a in the inner portion thereof. The first paper conveying path 4a is located on the upper right side, which is the paper feed direction, with respect to the paper feed cassette 2. The paper P fed out from the paper feed cassette 2 is conveyed vertically upward along the side surface of the printer body 1 by the first paper conveying path 4a.

A registration roller pair 13 is provided at the downstream end of the first paper conveying path 4a in the paper conveying direction. Furthermore, a first conveying unit 5 and the recording unit 9 are arranged immediately downstream of the registration roller pair 13 in the paper conveying direction. The paper P fed out from the paper feed cassette 2 reaches the registration roller pair 13 via the first paper conveying path 4a. The registration roller pair 13 feeds the paper P toward the first conveying unit 5 while correcting diagonal feeding of the paper P and measuring the timing with the ink ejection operation performed by the recording unit 9.

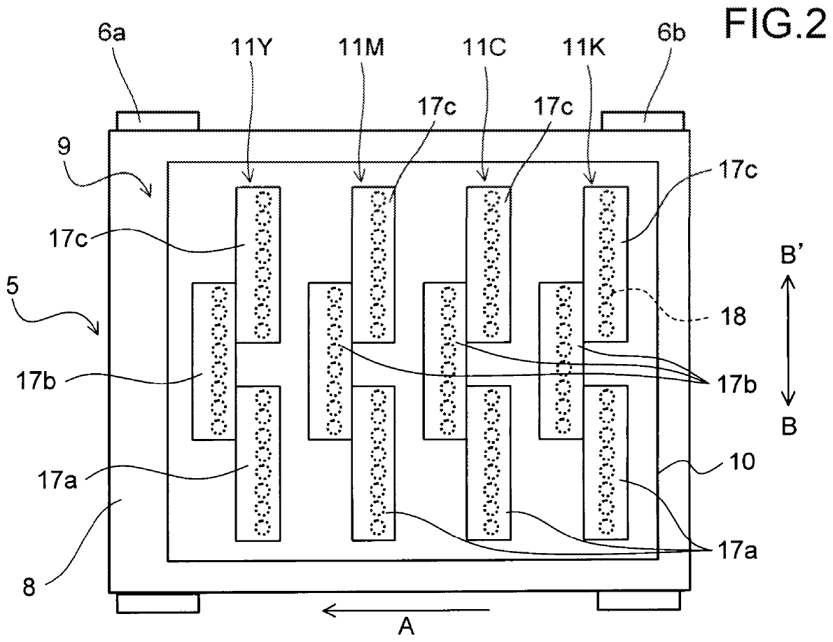

The paper P fed to the first conveying unit 5 is conveyed to a position facing the recording unit 9 (especially recording heads 17a to 17c described later) by the first conveyor belt 8 (see FIG. 2). An image is recorded on the paper P by ejecting ink from the recording unit 9 onto the paper P. At this time, the ejection of ink in the recording unit 9 is controlled by the control unit 110 in the inner portion of the printer 100. The control unit 110 includes, for example, a central processing unit (CPU).

The second conveying unit 12 is arranged on the downstream side (left side in FIG. 1) of the first conveying unit 5 in the paper conveying direction. The paper P on which the image is recorded by the recording unit 9 is sent to the second conveying unit 12. The ink ejected onto the surface of the paper P is dried while passing through the second conveying unit 12.

A decurler unit 14 is provided on the downstream side of the second conveying unit 12 in the paper conveying direction and near the left side surface of the printer body 1. The paper P whose ink has been dried by the second conveying unit 12 is sent to the decurler unit 14 in order to correct curling that has occurred in the paper P.

A second paper conveying path 4b is provided on the downstream side (upper side in FIG. 1) of the decurler unit 14 in the paper conveying direction. In a case where double-sided recording is not performed, paper P that has passed through the decurler unit 14 passes through the second paper conveying path 4b and is discharged to the paper discharge tray 15 provided in the outer portion of the left side surface of the printer 100.

A reverse conveying path 16 for performing double-sided recording is provided in the upper portion of the printer body 1 above the recording unit 9 and the second conveying unit 12. In a case of performing double-sided recording, the paper P that has passed through the second conveying unit 12 and the decurler unit 14 after recording on one surface (first surface) of the paper P is sent to the reverse conveying path 16 through the second paper conveying path 4b.

The conveying direction of the paper P sent to the reverse conveying path 16 is subsequently switched for recording on the other surface (second surface) of the paper P. Then, the paper P passes through the upper portion of the printer body 1 and is sent toward the right side, and is sent again, via the registration roller pair 13, to the first conveying unit 5 with the second surface thereof facing upward. In the first conveying unit 5, the paper P is conveyed to a position facing the recording unit 9, and an image is recorded on the second surface by ejecting ink from the recording unit 9. The paper P after double-sided recording is discharged to the paper discharge tray 15 via the second conveying unit 12, the decurler unit 14, and the second paper conveying path 4b in this order.

Moreover, a maintenance unit 19 and a cap unit 20 are arranged below the second conveying unit 12. When executing purging, the maintenance unit 19 moves horizontally below the recording unit 9, wipes the ink extruded from the ink ejection port of the recording head, and collects the wiped ink. Note that purging refers to an operation of forcibly extruding the ink from the ink ejection port of the recording head in order to discharge thickened ink, foreign matter and air bubbles in the ink ejection port. The cap unit 20 moves horizontally below the recording unit 9 when capping the ink ejection surface of the recording head, moves further upward, and is attached to the lower surface of the recording head.

FIG. 2 is a plan view of the recording unit 9. The recording unit 9 includes a head housing 10 and line heads 11Y, 11M, 11C and 11K. The line heads 11Y to 11K are held in the head housing 10 at a height at which specific spacing (for example, 1 mm) is formed with respect to the conveying surface of an endless first conveyor belt 8 that spans around a plurality of rollers including a drive roller 6a, a follower roller 6b, and another roller 7. Moreover, the line heads 11Y to 11K are arranged in this order from the downstream side to the upstream side in the traveling direction of the first conveyor belt 8.

The line heads 11Y to 11K have a plurality of (here, three) recording heads 17a to 17c, respectively. The recording heads 17a to 17c are arranged in a zigzag pattern along the paper width direction (direction of arrow BB′) orthogonal to the paper conveying direction (direction of arrow A). The recording heads 17a to 17c have a plurality of ink ejection ports 18 (nozzles). The ink ejection ports 18 are arranged at equal intervals in the width direction of the recording head, or in other words, the paper width direction (direction of arrow BB′). From the line heads 11Y to 11K, ink of each color of yellow (Y), magenta (M), cyan (C), and black (K) is respectively ejected via the ink ejection ports 18 of the recording heads 17a to 17c toward the paper P that is conveyed by the first conveyor belt 8.

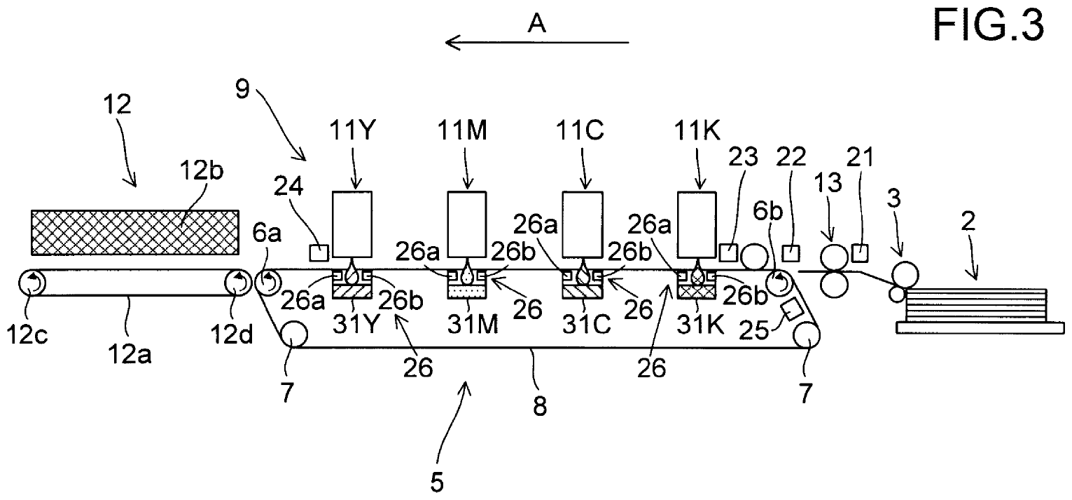

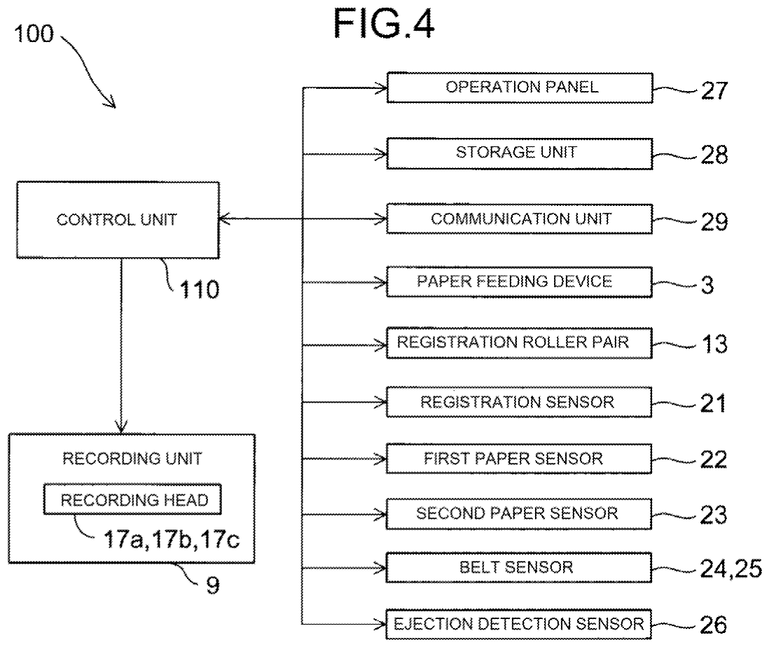

FIG. 3 schematically illustrates the configuration around the conveying path of the paper P from the paper feed cassette 2 to the second conveying unit 12 via the first conveying unit 5. Moreover, FIG. 4 is a block diagram illustrating a hardware configuration of a main part of the printer 100. The printer 100, in addition to the configuration described above, further includes a registration sensor 21, a first paper sensor 22, a second paper sensor 23, belt sensors 24 and 25, and an ejection detection sensor 26 (ejection detection unit).

The registration sensor 21 detects the paper P conveyed from the paper feed cassette 2 by the paper feeding device 3 and sent to the registration roller pair 13. The control unit 110 is able to control the rotation start timing of the registration roller pair 13 based on the detection result of the registration sensor 21. For example, the control unit 110 is able to control the supply timing of paper P after the skew (inclination) correction by the registration roller pair 13 to the first conveyor belt 8 based on the detection result of the registration sensor 21.

The first paper sensor 22 is a line sensor that detects the position in the width direction of the paper P sent from the registration roller pair 13 to the first conveyor belt 8. Based on the detection result of the first paper sensor 22, the control unit 110 is able to record an image on the paper P by causing ink to be ejected from the ink ejection openings 18 of each of the ink ejection ports 18 of the recording heads 17a to 17c of the line heads 11Y to 11K that correspond to the width of the paper P.

The second paper sensor 23 is a first detection sensor that detects the passage of the paper P supplied to the first conveyor belt 8 by the registration roller pair 13 as the recording medium supply unit. In other words, the second paper sensor 23 is a sensor for detecting the position in the conveying direction of the paper P conveyed by the first conveyor belt 8. The second paper sensor 23 is located upstream in the paper conveying direction of the recording unit 9 and downstream of the first paper sensor 22. Based on the detection result of the second paper sensor 23, the control unit 110 is able to control the ink ejection timing for the paper P reaching the position facing the line heads 11Y to 11K (recording heads 17a to 17c) by the first conveyor belt 8.

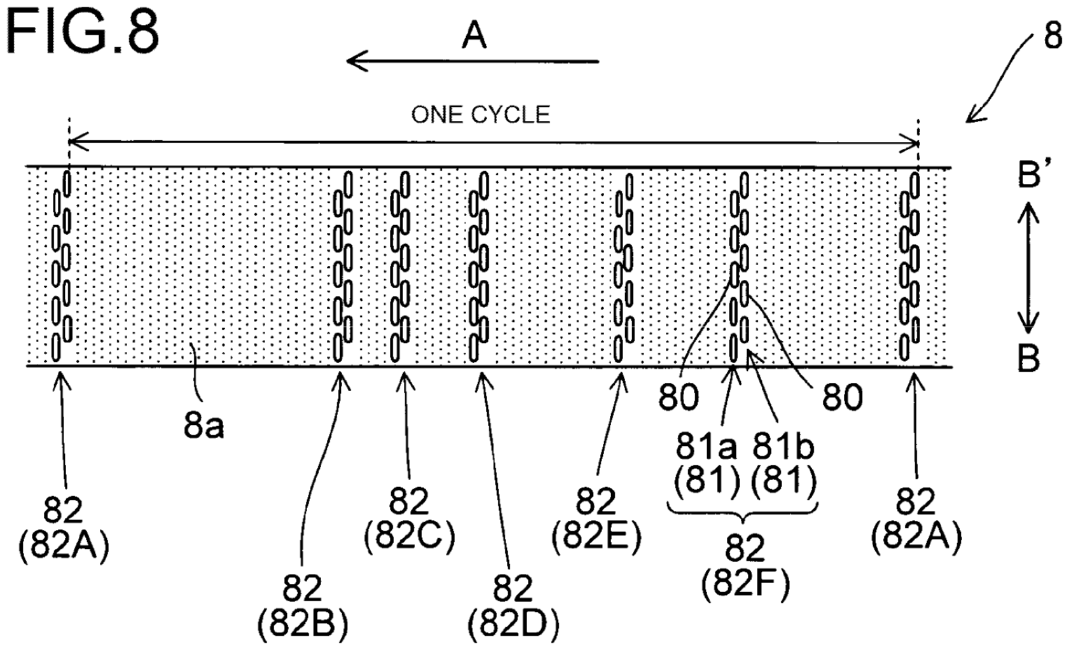

Belt sensors 24 and 25 detect the positions of a plurality of opening portion groups 82 (see FIG. 8), which will be described later, provided on the first conveyor belt 8. In other words, the belt sensors 24 and 25 are second detection sensors that detect the passage of at least one of the opening groups 82 due to the traveling of the first conveyor belt 8. The belt sensor 24 is located on the downstream side of the recording unit 9 in the paper conveying direction (the traveling direction of the first conveyor belt 8). The belt sensor 25 is located at position between the follower roller 6b and the other roller 7 where the first conveyor belt 8 is stretched around the follower roller 6b and the other roller 7. The follower roller 6b is located upstream of the recording unit 9 in the traveling direction of the first conveyor belt 8. Note that the belt sensor 24 also has the same function as the second paper sensor 23. The control unit 110 is able to control the registration roller pair 13 so as to supply paper P to the first conveyor belt 8 at a specific timing based on the detection result of the belt sensor 24 or 25.

Moreover, the positions of the paper are detected by a plurality of sensors (second paper sensor 23, belt sensor 24), and the positions of the opening portion groups 82 of the first conveyor belt 8 are detected by a plurality of sensors (belt sensors 24 and 25), and as a result, it is possible to correct error in the detected positions and detect an abnormality.

Ejection detection sensors 26 detect the presence or absence of ink ejection from each ink ejection port 18 of the recording heads 17a to 17c. Ejection detection sensors 26 are provided on the ink entry side (first conveyor belt 8 side) of the ink receiving portions 31Y to 31K, which will be described later, respectively. The ejection detection sensors 26 include a light emitting portion 26a and a light receiving portion 26b that are elongated in the belt width direction. Light emitting portion 26a and the light receiving portion 26b are arranged face the ejection path of the ink from the recording heads 17a to 17c to the ink receiving unit 31Y to 31K.

The ink ejected from the arbitrary ink ejection ports 18 of the recording heads 17a to 17c passes through the opening portions 80 of the first conveyor belt 8 and further passes between the light emitting portion 26a and the light receiving portion 26b. Then, the light received by the light receiving unit 26b of the light emitted from the light emitting unit 26a is temporarily blocked by the passage of the ink. On the other hand, when ink is not ejected from any of the ink ejection ports 18 of the recording heads 17a to 17c, light continues to be received by the light receiving portion 26b of the light emitted from the light emitting portion 26a. Therefore, the ejection detection sensor 26 is able to detect the presence or absence of ink ejection from the ink ejection ports 18 based on the light receiving state of the light receiving unit 26b. The control unit 110, based on the detection results of the ejection detection sensors 26, controls the flushing of the recording heads 17a to 17c (described later).

The first paper sensor 22, the second paper sensor 23, and the belt sensors 24 and 25 described above may be configured by a transmissive or reflective optical sensor or a CIS sensor (contact image sensor). Moreover, marks corresponding to the position of the opening portion groups 82 are formed at the end portion in the width direction of the first conveyor belt 8, and the belt sensors 24 and 25 detect the marks, whereby the positions of the opening portion groups 82 may be detected. Moreover, the ejection detection sensors 26 may be composed of a reflection type optical sensor, a CIS sensor, and a CCD (Charge Coupled Device) sensor.

In addition, the printer 100 may be configured to include a meandering detection sensor that detects the meandering of the first conveyor belt 8 and be configured to correct the meandering of the first conveyor belt 8 based on the detection result.

In addition, the printer 100 further includes an operation panel 27, a storage unit 28, and a communication unit 29. The operation panel 27 is an operation unit for receiving various setting input from the user. For example, the user may operate the operation panel 27 to input information about the size of the paper P set in the paper feed cassette 2, or in other words, the size of the paper P conveyed by the first conveyor belt 8. The storage unit 28 is a memory that stores an operation program of the control unit 110 and also stores various types of information, and includes a ROM (Read Only Memory), a RAM (Random Access Memory), a non-volatile memory, and the like. Information set by the operation panel 27 (for example, information about the size of the paper P) is stored in the storage unit 28. The communication unit 29 is a communication interface (for example, a personal computer (PC)) for transmitting and receiving information to and from the outside. For example, when the user operates the PC and transmits a print command together with image data to the printer 100, the image data and the print command are inputted to the printer 100 via the communication unit 29. In the printer 100, an image may be recorded on the paper P by the control unit 110 controlling the recording heads 17a to 17c to eject ink based on the image data.

Moreover, as illustrated in FIG. 3, the printer 100 has ink receiving units 31Y, 31M, 31C and 31K on the inner peripheral surface side of the first conveyor belt 8. When the recording heads 17a to 17c are made to execute flushing, the ink receiving units 31Y to 31K receive and collect the ink that has been ejected from the recording heads 17a to 17c and passed through the opening portions 80 of an opening portion groups 82 of the first conveyor belt 8 described later (see FIG. 8). Therefore, the ink receiving units 31Y to 31K are provided at positions facing the recording heads 17a to 17c of the line heads 11Y to 11K via the first conveyor belt 8. Note that the ink collected by the ink receiving units 31Y to 31K is sent to, for example, a waste ink tank and disposed of, however, may also be reused without being disposed of.

Here, flushing is the ejection of ink at timing different from the timing that contributes to image formation (image recording) on the paper P, and is for the purpose of reducing or preventing clogging of the ink ejection ports 18 due to ink drying. The execution of flushing in the recording heads 17a to 17c is controlled by the control unit 110.

The second conveying unit 12 described above is configured to include a second conveyor belt 12a and a dryer 12b. The second conveyor belt 12a is stretched around two drive rollers 12c and a follower roller 12d. The paper P that is conveyed by the first conveying unit 5 and on which an image has been recorded by ink ejected by the recording unit 9 is conveyed by the second conveyor belt 12a and dried by the dryer 12b while being conveyed to the decurler unit 14 described above.

### [2. Details of the First Conveying Unit]

### (2-1. Configuration Example of the First Conveying Unit)

In the present embodiment, a negative pressure suction method is adopted as a method for conveying the paper P in the first conveying unit 5. The negative pressure suction method is a method in which the paper P is sucked onto the first conveyor belt 8 by negative pressure suction and conveyed.

Here, as described above, the ink receiving units 31Y to 31K are provided at positions facing the recording heads 17a to 17c of the line heads 11Y to 11K via the first conveyor belt 8. During negative pressure suction, in a case where the suction force of the area where the ink receiving units 31Y to 31K are provided is strong, the ink ejected from the recording heads 17a to 17c at the time of flushing vigorously passes through the opening portions 80 of the first conveyor belt 8, then, the ink may collide with the liquid surface of ink already collected in the ink receiving unit 31Y to 31K, scattering ink into the surroundings and causing a mist to occur. In a case where a mist occurs, the scattered ink adheres to the inner peripheral surface of the first conveyor belt 8 and stains the inner peripheral surface. As a result, the surface of the rollers around which the first conveyor belt 8 is stretched may be stained, and uneven transportation of the first conveyor belt 8 (for example, meandering or slipping) may occur.

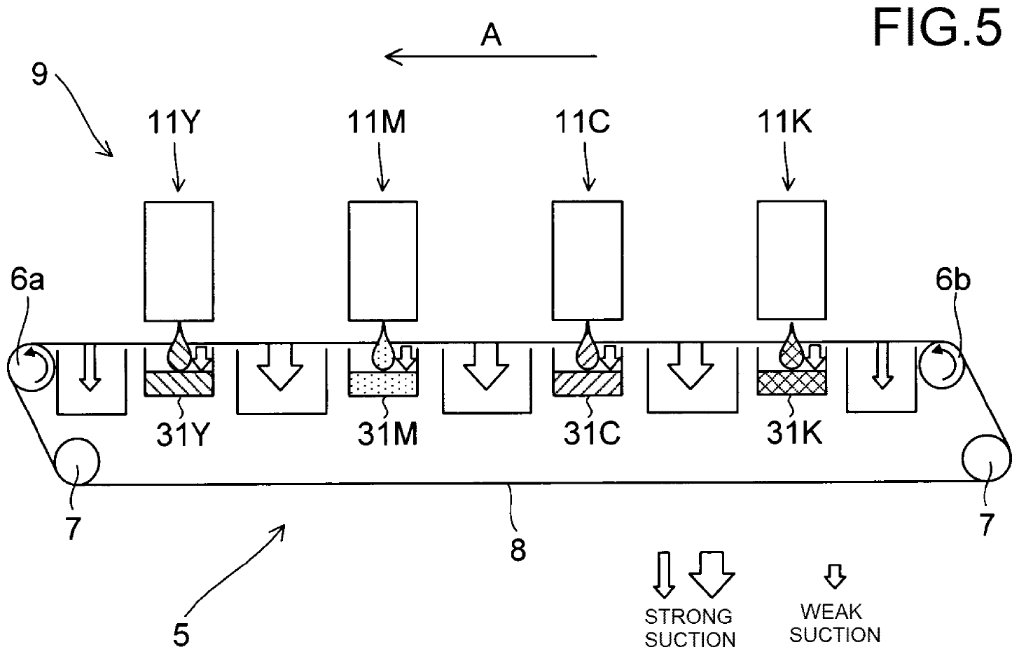

Therefore, in the present embodiment, as illustrated in FIG. 5, the suction force of the areas where the ink receiving units 31Y to 31K are provided, or in other words, the areas facing the line heads 11Y to 11K via the first conveyor belt 8 is made to be weaker than the upstream and downstream areas in the paper conveying direction. This reduces the above-mentioned inconvenience caused by the mist. More specifically, with the following configuration, areas with different suction forces are generated.

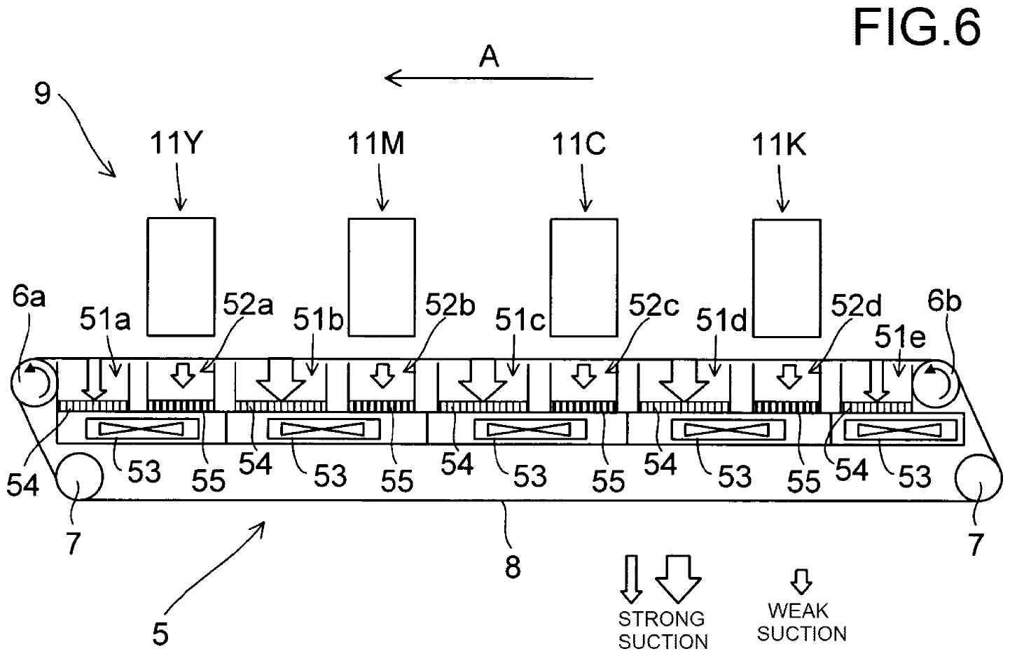

FIG. 6 is an explanatory diagram schematically illustrating a configuration example of the first conveying unit 5. First suction chambers 51a to 51e and second suction chambers 52a to 52d are provided on the inner peripheral surface side of the first conveyor belt 8 of the first conveying unit 5. The first suction chambers 51a to 51e and the second suction chambers 52a to 52d are formed in an elongated shape in the belt width direction of the first conveyor belt 8. The first suction chambers 51a to 51e and the second suction chambers 52a to 52d are open on the side facing the first conveyor belt 8.

The first suction chambers 51a to 51e are provided in this order from the downstream side to the upstream side in the paper conveying direction (direction A). The second suction chamber 52a is provided between the first suction chamber 51a and the first suction chamber 51b at a position facing the line head 11Y via the first conveyor belt 8. The second suction chamber 52b is provided between the first suction chamber 51b and the first suction chamber 51c at a position facing the line head 11M via the first conveyor belt 8. The second suction chamber 52c is provided between the first suction chamber 51c and the first suction chamber 51d at a position facing the line head 11C via the first conveyor belt 8. The second suction chamber 52d is provided between the first suction chamber 51d and the first suction chamber 51e at a position facing the line head 11K via the first conveyor belt 8. The ink receiving units 31Y to 31K described above are arranged in the second suction chambers 52a to 52d, respectively.

The inner portions of the first suction chambers 51a to 51e and the second suction chambers 52a to 52d are sucked by suction members 53. The suction member 53 sucks the paper P onto the first conveyor belt 8 by negative pressure suction. This kind of a suction member 53 is composed of, for example, a fan or a compressor. In the present embodiment, the inner portions of the first suction chamber 51a and the second suction chamber 52a are sucked by a common suction member 53. Moreover, the inner portions of the first suction chamber 51b and the second suction chamber 52b are sucked by a common suction member 53. Similarly, the inner portions of the first suction chamber 51c and the second suction chamber 52c are sucked by a common suction member 53, and the inner portions of the first suction chamber 51d and the second suction chamber 52d are sucked by a common suction member 53. The first suction chamber 51e is sucked alone by a suction member 53.

A filter 54 is arranged in each of the first suction chambers 51a to 51e, and a filter 55 is arranged in each of the second suction chambers 52a to 52d. Therefore, when each suction member 53 is driven, the inside of the first suction chambers 51a to 51e is sucked through the filter 54, and the inside of the second suction chambers 52a to 52d is sucked through the filter 55. As a result, the inner portions of the first suction chambers 51a to 51e and the second suction chambers 52a to 52d have a negative pressure, and air is sucked via the suction holes 8a that will be described later (see FIG. 8) or the opening portion groups 82 provided on the first conveyor belt 8, and the paper P is conveyed while being sucked to the first conveyor belt 8.

Here, the filter 54 is configured of a coarser mesh than the filter 55. Therefore, the resistance to the air passing through the filter 54 is lower than the resistance of the air passing through the filter 55. Therefore, in a case where each suction member 53 is driven by the same driving force, the inner portions of the first suction chambers 51a to 51e are sucked with a relatively strong suction force, and the inner portions of the second suction chambers 52a to 52d are sucked with a relatively weak suction force. As a result, the speed at which the ink ejected from the recording heads 17a to 17c during flushing passes through the opening portions 80 of the first conveyor belt 8 is suppressed, and scattering of ink (mist) due to collision with the liquid surface of ink accumulated in the ink receiving units 31Y to 31K may be reduced. This makes it possible to reduce the above-mentioned inconvenience caused by the mist.

### (2-2. Other Configuration Example of the First Conveying Unit)

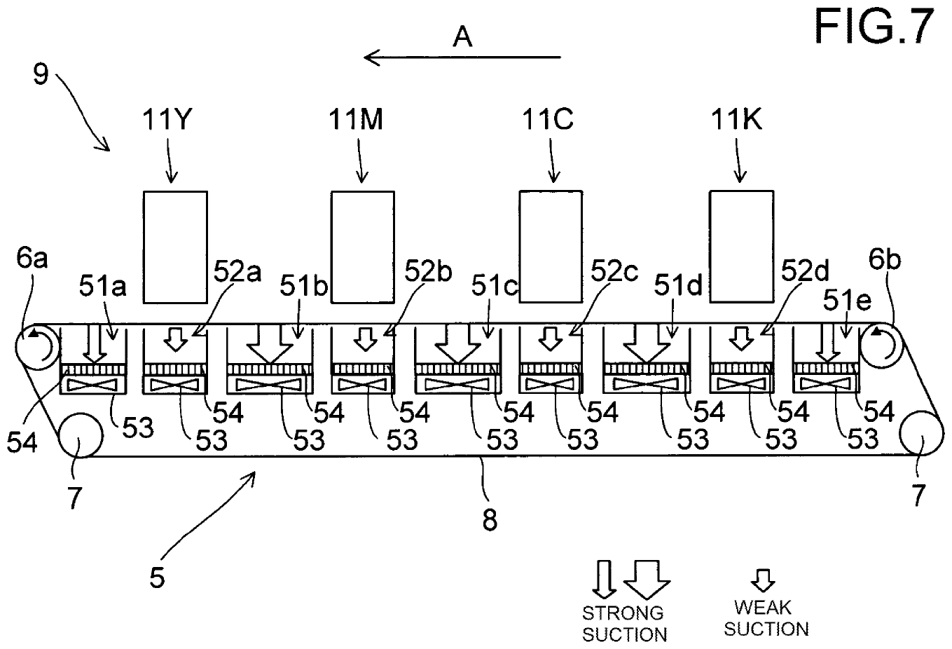

FIG. 7 is an explanatory diagram schematically illustrating another configuration example of the first conveying unit 5. In the first conveying unit 5 of FIG. 7, identical filters 54 are arranged in the first suction chambers 51a to 51e and the second suction chambers 52a to 52d illustrated in FIG. 6, and each of the first suction chambers 51a to 51e and the second suction chambers 52a to 52d is configured to be sucked by a different suction member 53. In such a configuration, by switching the driving force of each suction member 53 that sucks the inner portions of the second suction chambers 52a to 52d, the suction force of the second suction chambers 52a to 52d is switched between strong suction and weak suction. Note that the driving of each suction member 53 is controlled by the control unit 110, for example.

For example, when ink is ejected onto the paper P conveyed by the first conveyor belt 8 (at the time of recording an image), all of the suction members 53 that suck the first suction chambers 51a to 51e and the second suction chambers 52a to 52d are driven by a first driving force. On the other hand, at the time of flushing, each suction member 53 that sucks the first suction chambers 51a to 51e is driven by the first driving force, and each suction member 53 that sucks the second suction chambers 52a to 52d is driven by a second driving force that is lower than the first driving force. As a result, at the time of recording an image, the first suction chambers 51a to 51e and the second suction chambers 52a to 52d are strongly sucked to convey the paper P, and at the time of flushing, only the second suction chambers 52a to 52d are weakly sucked, making it possible to reduce mist. This makes it possible to reduce the above-mentioned inconvenience caused by the mist.

In addition, instead of using the filters 54 or 55, the diameters (flow passage cross-sectional areas) of the pipes that are the flow passages of the air sucked from the first suction chambers 51a to 51e and the second suction chambers 52a to 52d may be made different. In doing so, the suction force may be made different between the first suction chambers 51a to 51e and the second suction chambers 52a to 52d.

### [3. Details of the First Conveyor Belt]

### (3-1. Configuration Example of the First Conveyor Belt)

Next, details of the first conveyor belt 8 of the first conveying unit 5 will be described. FIG. 8 is a plan view illustrating a configuration example of the first conveyor belt 8. In the present embodiment, as described above, paper P is conveyed by the negative pressure suction method. In order for this, as illustrated in FIG. 8, the first conveyor belt 8 is provided with innumerable suction holes 8a through which suction air generated by negative pressure suction of the suction member 53 passes.

Moreover, the first conveyor belt 8 is also provided with opening portion groups 82. The opening portion groups 82 are sets of opening portions 80 through which ink ejected from each nozzle (ink ejection ports 18) of the recording heads 17a to 17c passes during flushing. The opening area of the opening portions 80 is larger than the opening area of the above-mentioned suction holes 8a. The first conveyor belt 8 has a plurality of opening portion groups 82 in one cycle in the conveying direction (direction A) of the paper P, and in the present embodiment there is six. Note that when distinguishing the opening portion groups 82 from each other, the six opening portion groups 82 are referred to as opening portion groups 82A to 82F from the downstream side in the A direction. The above-mentioned suction holes 8a are located between an opening portion group 82 and opening portion group 82 that are adjacent to each other in the A direction. In other words, in the first conveyor belt 8, the suction holes 8a are not formed in a region that overlaps an opening portion group 82.

The opening portion groups 82 are irregularly positioned in the A direction in one cycle of the first conveyor belt 8. In other words, in the A direction, the interval between an opening portion group 82 and the adjacent opening group 82 is not constant but changes (there are at least two types of the above-mentioned intervals). In this case, the maximum interval between two adjacent opening portion groups 82 in the A direction (for example, the distance between the opening portion group 82A and the opening portion group 82B in FIG. 8) is longer than the length in the A direction of the paper P when the minimum printable size (for example, A4 size horizontal placement)) paper P is placed on the first conveyor belt 8.

The opening portion groups 82 have opening portion rows 81. The opening portion rows 81 are configured by arranging a plurality of opening portions 80 in the belt width direction (paper width direction, BB′ direction) orthogonal to the A direction. One opening portion group 82 has at least one opening portion row 81 in the A direction, and in the present embodiment, has two opening portion rows 81. Note that when distinguishing the two opening portion rows 81 from each other, one is opening portion row 81a and the other is opening portion row 81b.

In one opening group 82, the opening portions 80 of any one of the opening portion rows 81 (for example, the opening portion row 81a) are positioned offset in the BB′ direction with respect to the opening portions 80 of the other opening row 81 (for example, the opening row 81b). Furthermore, the opening portions 80 of any one of the opening portion rows 81 (for example, the opening row 81a) are positioned so as to overlap a part of the opening portions 80 of the other opening portion rows 81 (for example, the opening row 81b) when viewed in the A direction. In addition, in each opening portion row 81, the plurality of opening portions 80 are located at equal intervals in the BB′ direction.

As described above, by arranging the plurality of opening portion rows 81 in the A direction to form one opening portion group 82, the width of the opening portion group 82 in the BB′ direction is larger than the width of the recording heads 17a to 17c in the BB′ direction. Therefore, the opening portion groups 82 cover all the ink ejection areas of the recording heads 17a to 17c in the BB′ direction, and the ink ejected from all the ink ejection ports 18 of the recording heads 17a to 17c during flushing passes through the opening potions 80 of one of the opening portion groups 82. Therefore, clogging can be reduced or prevented for the ink ejection ports 18 at all positions of the recording heads 17a to 17c in the BB′ direction. Moreover, the opening portions 80 are partially overlapped with each other when viewed in the A direction, so flushing may be performed on part of the ink ejection ports 18 regardless of which the opening portions 80 of opening portion row 81 is used. In other words, the timing for ejecting ink from the ink ejection ports 18 at the time of flushing may be selected.

### (3-2. Opening Portion Group Pattern Used During Flushing)

In the present embodiment, the control unit 110 records an image on paper P by driving the recording heads 17a to 17c based on image data transmitted from the outside (for example, a PC) while paper P is conveyed using the first conveyor belt 8 described above. At this time, by causing the recording heads 17a to 17c to perform flushing (inter-paper flushing) between the conveyed paper P and paper P, clogging of the ink ejection ports 18 is reduced or prevented.

Here, in the present embodiment, the control unit 110 sets the pattern (combination) in the A direction of the plurality of opening portion groups 82 used during flushing according to the size of the paper P to be used in one cycle of the first conveyor belt 8. Note that the size of the paper P to be used may be recognized by the control unit 110 based on information stored in the storage unit 28 (size information about the paper P inputted using the operation panel 27).

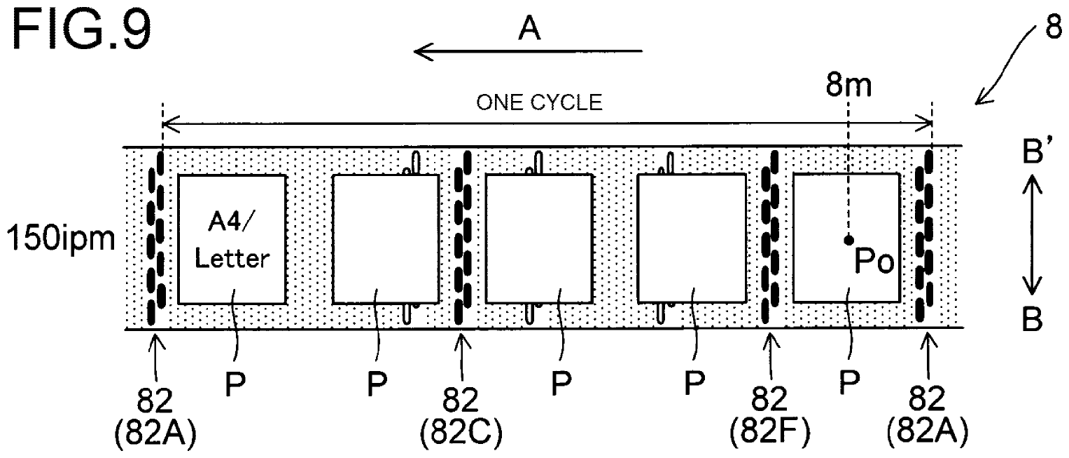

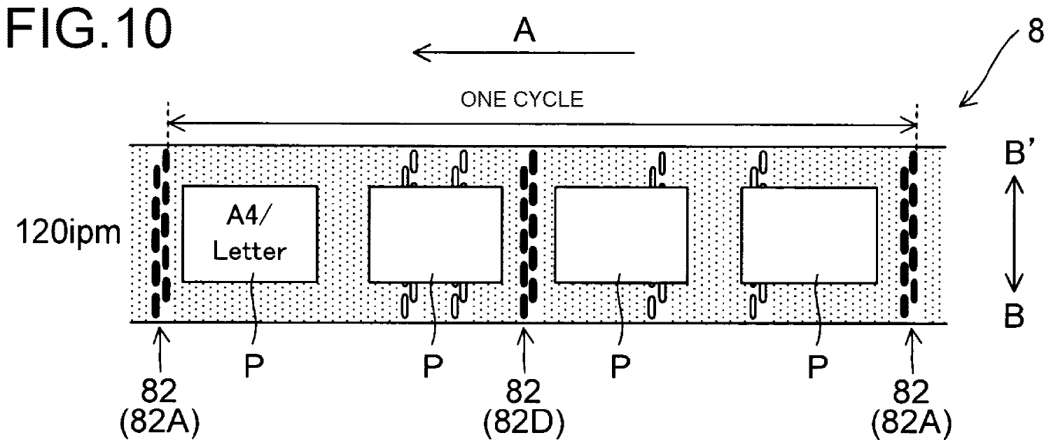

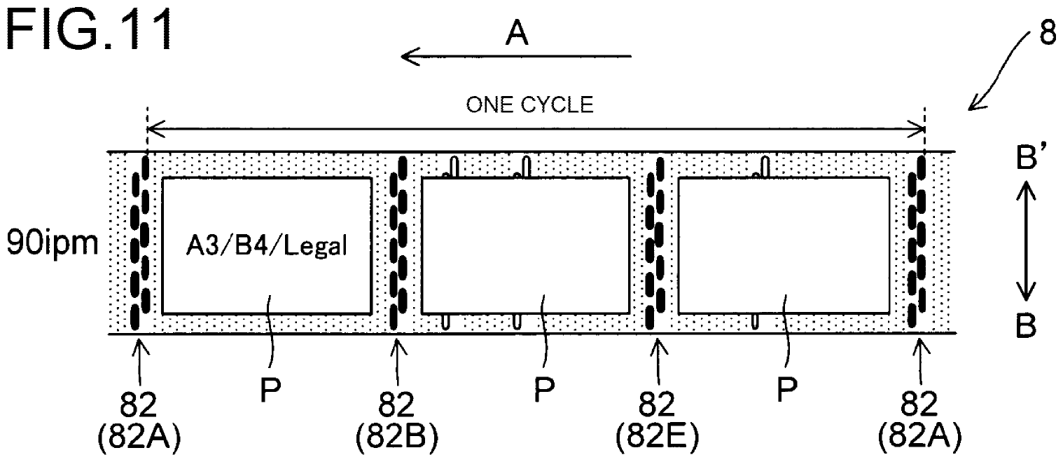

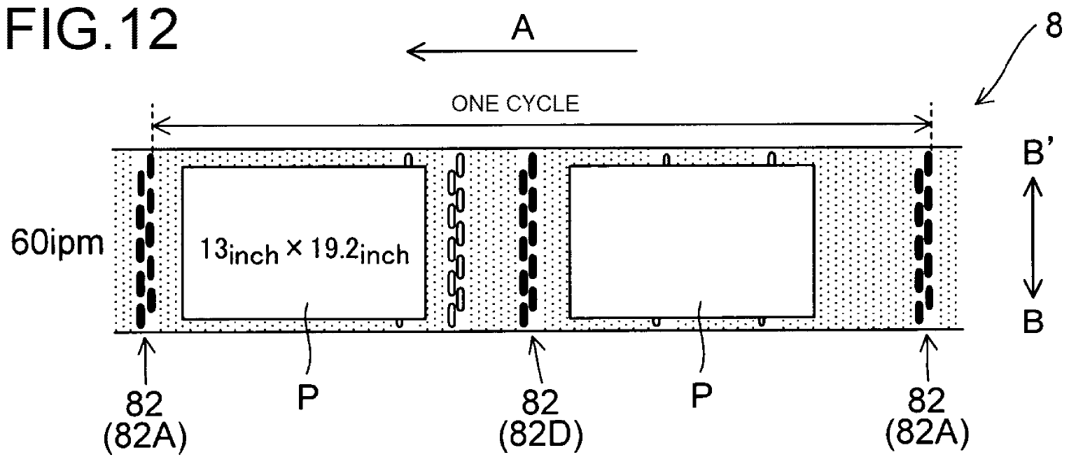

FIGS. 9 to 12 each illustrates an example of the above patterns for each kind of paper P. For example, in a case where the paper P to be used is A4 size (horizontal placement) or letter size (horizontal placement), the control unit 110 selects the pattern of the opening portion groups 82 illustrated in FIG. 9. In other words, the control unit 110 selects the opening portion groups 82A, 82C, and 82F from among the six opening portion groups 82 illustrated in FIG. 8 as the opening portion groups 82 to be used during flushing. In a case where the paper P to be used is A4 size (vertical placement) or letter size (vertical placement), the control unit 110, as illustrated in FIG. 10, selects the opening portion groups 82A and 82D, from among the six opening portion groups 82 as the opening portion groups 82 to be used for flushing. In a case where the paper P to be used is A3 size, B4 size, or legal size (all vertically placed), the control unit 110, as illustrated in FIG. 11, selects the opening portion groups 82A, 82B, and 82E from among the six opening groups 82 as the opening portion groups 82 to be used during flushing. In a case where the paper P to be used is size 13 inches×19.2 inches, the control unit 110, as illustrated in FIG. 12, selects the opening portion groups 82A and 82D from among the six opening groups 82 as the opening portion groups 82 to be used during flushing. Note that in each of the figures, the opening portions 80 of the opening portion groups 82 belonging to the above patterns are illustrated in black for convenience.

Then, the control unit 110, by the traveling of the first conveyor belt 8, causes the recording heads 17a to 17c to execute flushing at the timing when the opening portion groups 82 positioned in the determined pattern face the recording heads 17a to 17c. Here, the traveling speed of the first conveyor belt 8 (paper conveying speed), the spacing between the opening portion groups 82A to 82E, and the positions of the recording heads 17a to 17c with respect to the first conveyor belt 8 are all understandable. Therefore, when the belt sensor 24 or 25 detects that a reference opening portion group 82 (for example, the opening portion group 82A) has passed due to the traveling of the first conveyor belt 8, it is understood how many seconds after the detection time the opening groups 82A to 82E pass through the positions facing the recording heads 17a to 17c. Therefore, the control unit 110, based on the detection results of the belt sensor 24 or 25, is able to cause the recording heads 17a to 17c to execute flushing at timing when the opening portion groups 82 positioned in the determined pattern described above face the recording heads 17a to 17c.

At this time, the control unit 110, based on the detection result of the belt sensor 24 or 25, controls flushing by the recording heads 17a to 17c so that the ink passes through the same opening portion group 82 in each cycle of the first conveyor belt 8 for each class determined according to the size of the paper P.

For example, a case (first class) where the size of the paper P used is A4 size (horizontal placement) or letter size (horizontal placement) will be described. In this case, the control unit 110 controls flushing by the recording heads 17a to 17c so that ink passes trough the same opening portion groups 82A, 82C, and 82F illustrated in FIG. 9 in each cycle of the first conveyor belt 8. A case (second class) where the size of the paper P used is A4 size (vertical placement) or letter size (vertical placement) will be described. In this case, the control unit 110 controls flushing by the recording heads 17a to 17c so that ink passes trough the same opening portion groups 82A and 82D illustrated in FIG. 10 in each cycle of the first conveyor belt 8. A case (third class) where the size of the paper P used is A3 size, B4 size or legal size (each vertically placed) will be described. In this case, the control unit 110 controls flushing by the recording heads 17a to 17c so that ink passes trough the same opening portion groups 82A, 82B, and 82E illustrated in FIG. 11 in each cycle of the first conveyor belt 8. A case (fourth class) where the size of paper P used is 13 inches×19.2 inches will be described. In this case, the control unit 110 controls flushing by the recording heads 17a to 17c so that ink passes trough the same opening portion groups 82A and 82D illustrated in FIG. 12 in each cycle of the first conveyor belt 8.

Moreover, the control unit 110 controls the supply of the paper P to the first conveyor belt 8 so as to be shifted in the A direction from the opening portion groups 82 positioned in the determined pattern. In other words, the control unit 110 causes the registration roller pair 13 as a recording medium supply unit to supply the paper P between the plurality of opening portion groups 82 arranged in the A direction in the pattern described above on the first conveyor belt 8.

For example, a case where the paper P used is A4 size (horizontal placement) or letter size (horizontal placement) will be described. In this case, as illustrated in FIG. 9, the control unit 110 controls the registration roller pair 13 to supply the paper P to the first conveyor belt 8 at a specific supply timing so that on the first conveyor belt 8, two sheets of paper P are arranged between the opening portion group 82A and the opening portion group 82C, two sheets of paper P are arranged between the opening portion group 82C and the opening portion group 82F, one sheet of paper P is arranged between the opening group 82F and the opening group 82A. In this case, the control unit 110 controls the registration roller pair 13 to supply paper P to the first conveyor belt 8 so that on the first conveyor belt 8 each sheet of paper P is arranged at a position separated from the opening portion groups 82A, 82C, and 82F positioned in the above pattern by a specific distance or more in the A direction. Note that the specific distance above is set to 10 mm as an example here. The A direction includes both upstream and downstream directions.

Here, the supply timing of the paper P by the registration roller pair 13 can be determined by the control unit 110 based on the detection result of the belt sensor 24 or 25. For example, the belt sensor 24 or 25 detects that a reference opening portion group 82 (for example, the opening portion group 82A) has passed by due to the traveling of the first conveyor belt 8. Then, the control unit 110 is able to determine how many seconds after the detection time the paper P can be arranged at each position illustrated in FIG. 9 by supplying the paper P to the first conveyor belt 8 by the registration roller pair 13. Therefore, the control unit 110 determines the supply timing of the paper P based on the detection result of the belt sensor 24 or 25, and controls the registration roller pair 13 so that the paper P is supplied at the determined supply timing. As a result, the paper P can be arranged on the first conveyor belt 8 at the respective positions illustrated in FIG. 9 at approximately equal intervals. In the example of FIG. 9, five sheets of paper P can be conveyed in one cycle of the first conveyor belt 8, and 150 ipm (images per minute) can be achieved as the number of printed sheets of paper P per minute (productivity).

Furthermore, as illustrated in FIG. 9, in a case where A4 size (horizontal placement) paper P is supplied to the first conveyor belt 8, only one sheet of paper P is supplied between the opening portion group 82F and the opening portion group 82A of the first conveyor belt 8. In this case, the control unit 110 controls the registration roller pair 13 based on the detection result of the belt sensor 24 or 25, so that the center Po of the paper P in the A direction is located at an intermediate position 8m between the opening portion group 82F and the opening portion group 82A. Then, the control unit 110 causes paper P to be supplied from the registration roller pair 13 to the first conveyor belt 8.

On the other hand, a case where the paper P used is A4 size (vertical placement) or letter size (vertical placement) will be described. In this case, as illustrated in FIG. 10, the control unit 110 controls the registration roller pair 13 so that two sheets of paper P are arranged on the first conveyor belt 8 between the opening portion group 82A and the opening portion group 82D, and so that two sheets of paper P are arranged between the opening portion group 82D and the opening portion group 82A, and then controls the registration roller pair 13 to cause the paper P to be supplied to the first conveyor belt 8 at a specific supply timing. In the example of FIG. 10, four sheets of paper P can be conveyed in one cycle of the first conveyor belt 8, and a productivity of 120 ipm can be achieved.

A case in which the paper P to be used is A3 size, B4 size, or legal size (all vertically place) will be described. In this case, as illustrated in FIG. 11, the control unit 110 controls the registration roller pair 13 to supply the paper P to the first conveyor belt 8 at a specific supply timing so that on the first conveyor belt 8, one sheet of paper P is arranged between the opening portion group 82A and the opening portion group 82B, one sheet of paper P is arranged between the opening portion group 82B and the opening portion group 82E, and one sheet of paper P is arranged between the opening group 82E and the opening group 82A. In the example of FIG. 11, three sheets of paper P can be conveyed in one cycle of the first conveyor belt 8, and a productivity of 90 ipm can be achieved. Note that preferably the control unit 110 causes the paper P to be supplied to the first conveyor belt 8 by controlling the registration roller pair 13 based on the detection result of the belt sensor 24 or 25 so that the center of one sheet of paper P in the A direction is positioned at an intermediate position between two adjacent opening portion groups 82 included in the determined pattern.

A case in which the paper P used has a size of 13 inches×19.2 inches will be described. In this case, as illustrated in FIG. 12, the control unit 110 controls the registration roller pair 13 so that one sheet of paper P is arranged on the first conveyor belt 8 between the opening portion group 82A and the opening portion group 82D, and so that one sheet of paper P is arranged between the opening portion group 82D and the opening portion group 82A, and then causes the paper P to be supplied to the first conveyor belt 8 at a specific supply timing. In the example of FIG. 12, two sheets of paper P can be conveyed in one cycle of the first conveyor belt 8, and a productivity of 60 ipm can be achieved.

As described above, the control unit 110 determines the pattern (combination) in the A direction of the plurality of opening portion groups 82 used during flushing according to the size of the paper P used. As a result, regardless of which size paper P is used, it is possible to arrange as many sheets of paper P as possible on the first conveyor belt 8 so as not to overlap the opening portion groups 82 arranged in the above-described patterns. Therefore, regardless of which size of paper P is used, it is possible to avoid a decrease in productivity (a decrease in the number of printed sheets).

Moreover, during one cycle of the first conveyor belt 8, it is possible to perform flushing a plurality of times by using the plurality of opening portion groups 82 positioned in the above-described patterns. Therefore, regardless of which size of paper P used, it is possible to reduce insufficient flushing and clogging of the nozzles (ink ejection ports 18) due to insufficient flushing. In particular, the control unit 110 causes the recording head 17 to execute flushing at a timing when the opening portion group 82 positioned in an above-described pattern faces the recording heads 17a to 17c due to traveling of the first conveyor belt 8. Accordingly, flushing may be reliably performed a plurality of times during one cycle of the first conveyor belt 8 and insufficient flushing may be eliminated.

Moreover, it is not necessary to reduce the conveying speed of the paper P in order to eliminate insufficient flushing, so it is possible to contribute to the improvement of productivity from this aspect as well. In addition, it is not necessary to change the conveying speed of the paper P, so complicated control for conveying the paper P (complicated drive control of the first conveyor belt 8) is also unnecessary.

### (3-3. Other Configuration Example of the First Conveyor Belt)

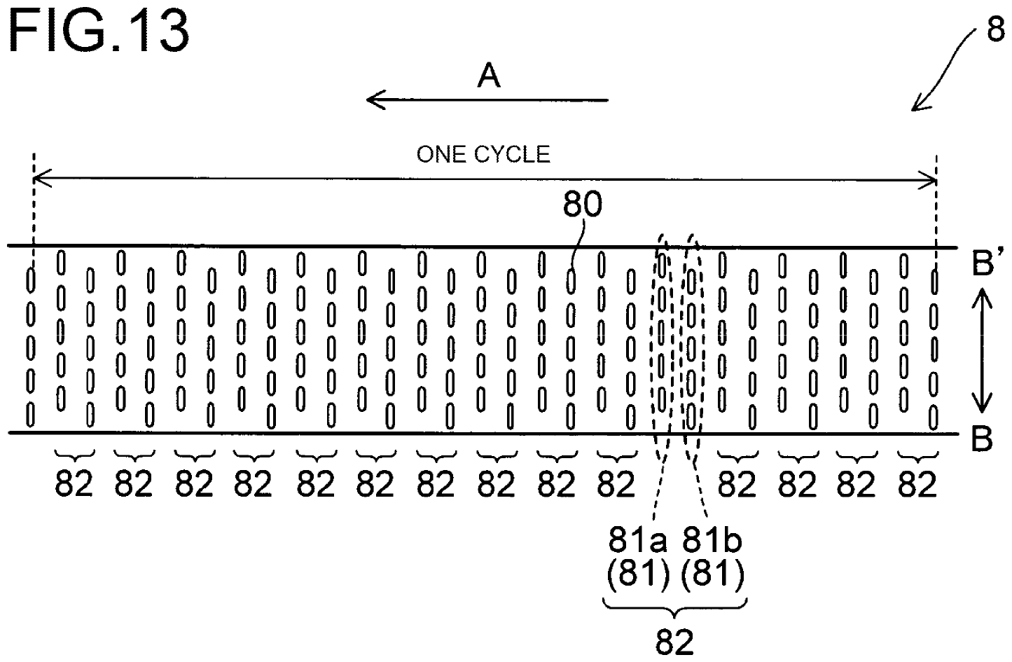

FIG. 13 is a plan view illustrating another configuration example of the first conveyor belt 8. The first conveyor belt 8 may have a configuration in which the opening portion groups 82 described above are located at equal intervals in the conveying direction of the first conveyor belt 8, or in other words, the A direction. In this case, two opening portion groups 82 adjacent to each other in the A direction are arranged at intervals shorter than the length of the paper P in the A direction when the smallest printable size of the paper P is placed on the first conveyor belt 8. In addition, in the configuration of FIG. 13, the opening portions 80 that constitute the opening portion groups 82 also serve as suction holes 8a in the configuration of FIG. 8. Note that the opening portion groups 82 have a plurality of opening portion rows 81, and one opening portion row 81 has a plurality of opening portions 80 arranged at equal intervals in the BB′ direction, or in other words, is the same as the first conveyor belt 8 described in FIG. 8 and the like.

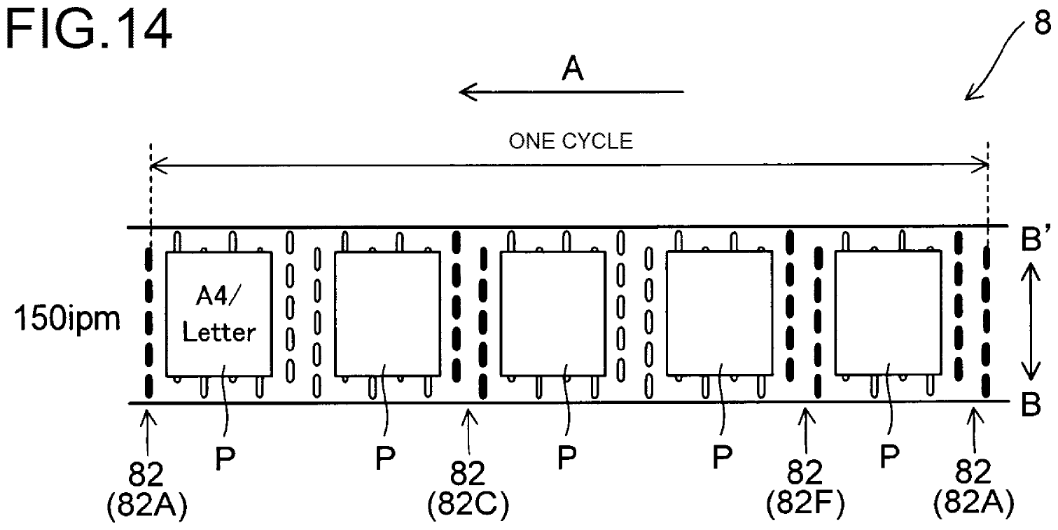

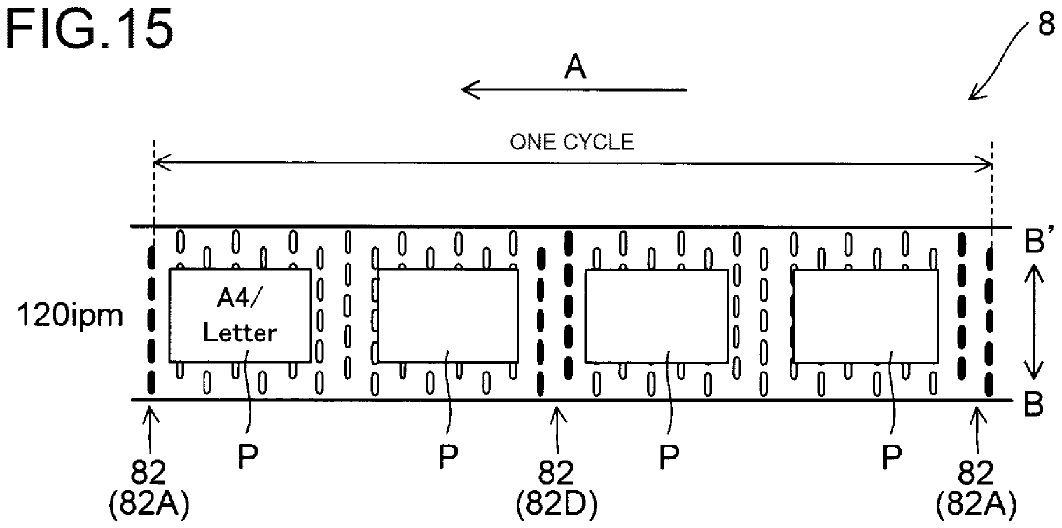

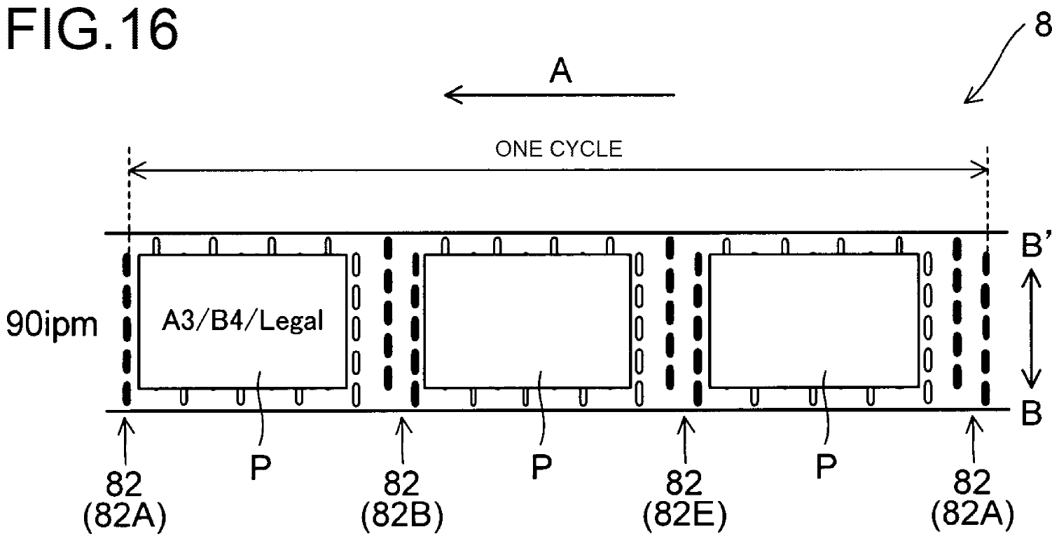

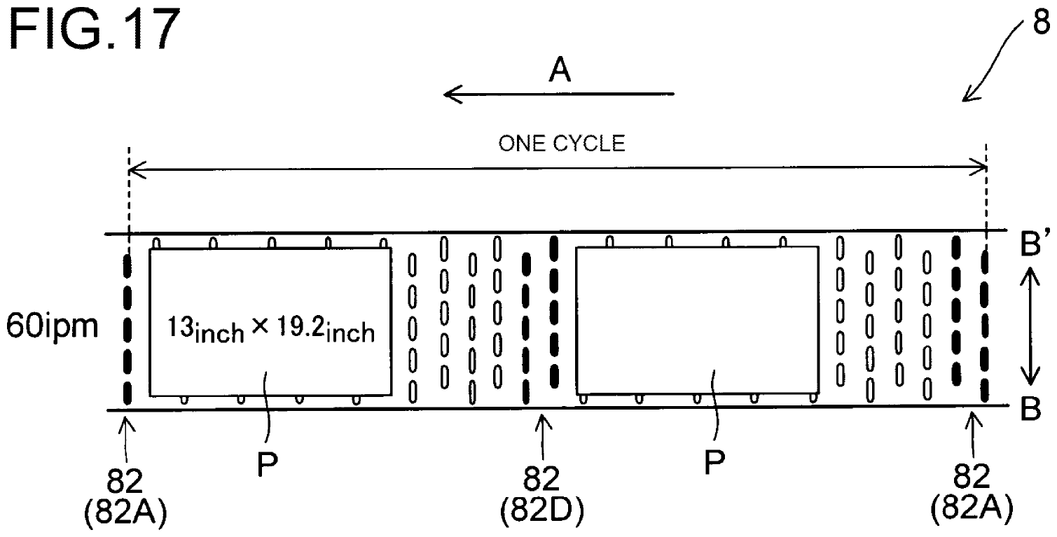

Even in a case where the first conveyor belt 8 illustrated in FIG. 13 is used, the control unit 110, as in the case of using the first conveyor belt 8 illustrated in FIG. 8, determines a pattern of the plurality of opening portion groups 82 in the A direction that will be used according to the size of the paper P to be used. For example, in a case where the paper P to be used is A4 size (horizontal placement) or letter size (horizontal placement), the control unit 110 selects the pattern of the opening portion groups 82 illustrated in FIG. 14. In a case where the paper P to be used is A4 size (vertical placement) or letter size (vertical placement), the control unit 110 selects the pattern of the opening portion groups 82 illustrated in FIG. 15. In a case where the paper P to be used is A3 size, B4 size, or legal size (each vertically placed), the control unit 110 selects the pattern of the opening portion groups 82 illustrated in FIG. 16. In a case where the paper P to be used has a size of 13 inches×19.2 inches, the control unit 110 selects the pattern of the opening portion groups 82 illustrated in FIG. 17. Note that, in FIGS. 14 to 17, for convenience, the opening portion groups 82 in positions corresponding to the opening portion groups 82A to 82F in FIG. 8 are illustrated as the opening portion groups 82A to 82F.

Then, the control unit 110, by the traveling of the first conveyor belt 8, causes the recording heads 17a to 17c to execute flushing at the timing when the opening portion groups 82 positioned in the determined pattern face the recording heads 17a to 17c.

In addition, the control unit 110 causes the registration roller pair 13 to supply the paper P to the position illustrated in FIGS. 14 to 17 on the first conveyor belt 8 (between the plurality of opening portion groups 82 arranged in the direction A in the above pattern). At this time, the control unit 110 controls the registration roller pair 13 so that each sheet of paper P is arranged on the first conveyor belt 8 at a position separated from the opening portion groups 82 positioned in the above pattern by a specific distance or more in the direction A, and then, the control unit 110 causes the paper P to be supplied to the first conveyor belt 8. The A direction includes both the upstream side and the downstream side directions.

As described above, even in a case where the first conveyor belt 8 illustrated in FIG. 13 is used, the control unit 110 performs the same control (flushing control, paper P supply control) as that when the first conveyor belt 8 illustrated in FIG. 8 is used, and as a result it is possible to obtain the same effects as described above. The same effect as described above is that, regardless of the size of the paper P, clogging of the nozzle due to insufficient flushing may be reduced while avoiding a decrease in productivity.

Note that in the first conveyor belt 8 configured as illustrated in FIG. 13, innumerable opening portions 80 for flushing are formed over the entire surface of the belt. Therefore, the paper P can be packed and conveyed in the A direction on the first conveyor belt 8, and by performing flushing using the opening portions 80 at a position not overlapped by the paper P, it is possible to significantly improve productivity. However, when the paper P is conveyed in such a manner, the opening portions 80, which become stained due to the passage of ink during flushing, and the paper P to be conveyed are likely to overlap with each other in each cycle of the first conveyor belt 8, making it easier for the paper P to become stained.

Even with a configuration using the first conveyor belt 8 in FIG. 13, as described above, the pattern of the opening portion groups 82 used at the time of flushing is determined according to the size of the paper P, and flushing is performed using the opening portion groups 82 positioned in the determined pattern. As a result, together with being able to perform flushing using the same opening portion groups 82 in each cycle, the paper P can be arranged and conveyed at positions shifted from the opening portion groups 82 used for flushing. Accordingly, it is possible to reduce stains on the paper P when the paper P is conveyed and printed over a plurality of cycles while at the same time maintain productivity. In this respect, the flushing control and the paper P supply control described in the present embodiment are effective even when the first conveyor belt 8 having the configuration of FIG. 13 is used.

Note that in a case where the paper P is conveyed by the first conveyor belt 8 illustrated in FIG. 13, the pattern of the opening portion groups 82 used during flushing may be a different pattern than the pattern used in a case where the first conveyor belt 8 illustrated in FIG. 8 is used. For example, the flushing may be performed on the opening portion groups located between the paper P and the paper P conveyed at the positions illustrated in FIGS. 14 to 17.

In the description above, a case is explained in which the paper P is sucked to the first conveyor belt 8 by negative pressure and conveyed, however, the first conveyor belt 8 may be electrically charged and the paper P may be electrostatically sucked to the first conveyor belt 8 and conveyed (electrostatic attraction method). Even in this case, the same effect as that of the present embodiment may be obtained by performing flushing control and supply control of the paper P to the first conveyor belt 8 in a manner similar to the present embodiment.

In the description above, an example is described in which a color printer that records a color image using four colors of ink is used as the inkjet recording apparatus. However, the control described above may be applied even in a case where a monochrome printer that records a monochrome image using black ink is used.

### [4. Flushing Control Based on the Detection Result of the Ejection Detection Sensor]

As described above, flushing (particularly flushing between paper) in which ink is ejected from the recording heads 17a to 17c is performed at the timing when the opening portions 80 face the recording heads 17a to 17c due to the traveling of the first conveyor belt 8. As a result, the ink passes through the opening portions 80 and does not adhere to the paper P placed between an opening portion groups 82 and an opening group 82 adjacent to each other in the conveying direction on the first conveyor belt 8, so it is possible to avoid deterioration of the image quality of the recorded image on the paper P. The flushing described above is also referred to herein as the “first flushing”.

Normally, the control unit 110 causes the recording heads 17a to 17c to execute the first flushing for the purpose of reducing clogging of the ink ejection ports 18 due to drying of the ink and avoiding deterioration of the image quality of the recorded image. However, when ink drying progresses after the first flushing and a state occurs in which the ink ejection ports 18 do not eject ink, it becomes impossible to record an image on the paper P by using the ink ejection ports 18. In this case, it is necessary to improve the ejection failure of the ink ejection port 18 at an early stage. Note that an ink ejection port 18 from which ink is not ejected is also referred to as a “non-ejecting nozzle” here.

Therefore, in the present embodiment, the control unit 110 determines the presence or absence of non-ejecting nozzles based on the detection result of the ejection detection sensor 26 (see FIGS. 3 and 4), and the method of flushing is changed. The details of flushing control will be described below.

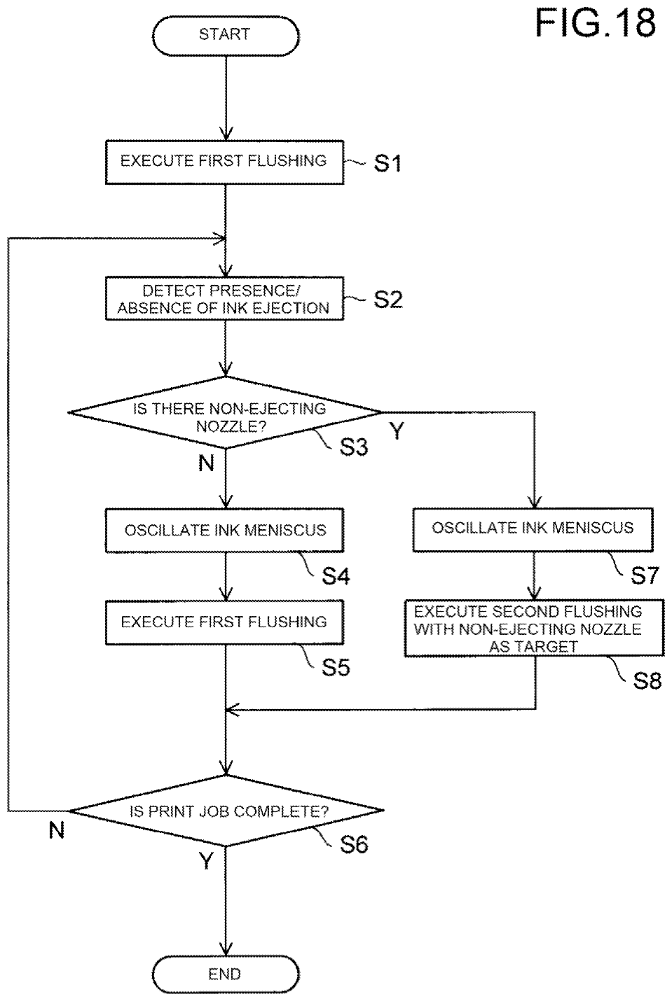

FIG. 18 is a flowchart illustrating the flow of processing by the flushing control of the present embodiment. First, the control unit 110 causes the recording heads 17a to 17c to perform the first flushing by the method described above (51). Next, the ejection detection sensor 26 detects the presence or absence of ink ejection from each ink ejection port 18 (S2). Then, in a case where the control unit 110 determines that there is no non-ejecting nozzle based on the detection result of the ejection detection sensor 26 (NO in S3), the control unit 110 causes the recording heads 17a to 17c to execute oscillation of the ink meniscus in all the ink ejection ports 18 (S4). Then, after that, the control unit 110 continuously causes the recording heads 17a to 17c to execute the first flushing (S5). In S5, the second flushing described later is not performed, but the first flushing is performed.

Here, the ink meniscus refers to the outermost surface of the ink ejection port 18 on the ink ejection side. By oscillating (vibrating) the ink meniscus during the non-ejection period of the ink determined based on the image data, it is possible to avoid an increase in viscosity due to drying of the ink and stabilize the ejection of the ink at the time of ink ejection. More specifically, such oscillating of the ink meniscus may be performed as follows. For example, in the piezoelectric recording heads 17a to 17c, a minute voltage is applied to the piezoelectric element during the non-ejection period of the ink, and the vibrating plate forming the upper wall of the pressure chamber is vibrated by the piezoelectric effect of the piezoelectric element. As a result, the vibration described above is transmitted to the ink meniscus of the ink ejection port 18 via the ink in the pressure chamber, and the ink meniscus may be oscillated.

After causing the recording heads 17a to 17c to execute the first flushing in S5, the control unit 110 determines whether or not the print job has been completed (S6), and in a case where the print job is completed, ends a series of processes, and in a case were the print job is not completed, returns to S2 and repeats the processing starting from S2.

On the other hand, in S3, in a case where the control unit 110 determines that there is a non-ejecting nozzle based on the detection result of the ejection detection sensor 26 (YES in S3), and similar to S4, the control unit 110 causes the recording heads 17a to 17c to oscillate the ink meniscus at all the ink ejection ports 18 (S7). Then, after that, the control unit 110 continuously causes the recording heads 17a to 17c to execute the second flushing (S8).

Here, the second flushing is flushing (also called star flushing) in which ink the recording heads 17a to 17c are caused to eject ink at timing at which the paper P on the first conveyor belt 8 faces the recording heads 17a to 17c due to traveling of the first conveyor belt 8. The second flushing may be performed as targeting all the ink ejection ports 18; however, in the present embodiment, second flushing is performed as targeting the non-ejecting nozzles determined in S3. Note that the “second flushing targeting the non-ejecting nozzles” means that the ink is forcibly ejected only from the non-ejecting nozzles to perform the second flushing. For example, by applying a voltage only to the actuator (piezoelectric element) that drives the pressure chamber corresponding to the non-ejecting nozzle, ink can be forcibly ejected only from the non-ejecting nozzle.

In S8, the first flushing may be performed in addition to the second flushing. The order in which the first flushing and the second flushing are performed may be arbitrary. In other words, in a case where it is possible to perform the first flushing before the second flushing, the first flushing may be performed at that timing. In other words, in a case where it is possible to perform the first flushing after the second flushing, the first flushing may be performed at that timing.

After flushing including the second flushing is executed by the recording heads 17a to 17c in S8, the process proceeds to S6, and subsequent processing is performed in S2 as necessary. Therefore, for example, in S8, after the second flushing targeting the non-ejecting nozzle is executed by the recording heads 17a to 17c, the process proceeds to S2 via S6. Then, in a case where it is determined that there is no non-ejecting nozzle based on the detection result of the ejection detection sensor 26 (NO in S2 and S3), then the ink meniscus oscillates (S4) and the first flushing (S5) is executed. In other words, after performing the second flushing, if there is no non-ejecting nozzle, the flushing is returned to the first flushing.

As described above, when the recording heads 17a to 17c perform the first flushing (S1), the control unit 110 determines the presence or absence of the non-ejecting nozzle based on the detection result of the ejection detection sensor 26 (S2, S3). Then, based on the determination result of the presence or absence of the non-ejecting nozzle, as the subsequent flushing, either the second flushing is performed or not is selected and the recording heads 17a to 17c are caused to execute (S5, S8).

According to the above control by the control unit 110, for example, when there is no non-ejecting nozzle after the first flushing, after that, without causing the recording heads 17a to 17c to execute subsequent second flushing, the recording heads 17a to 17c are caused to execute first flushing, and it is possible to reduce or prevent clogging of each ink ejection port 18 due to drying of the ink. On the other hand, for example, in a case where there is a non-ejecting nozzle after the first flushing, after that, by causing the recording heads 17a to 17c to execute the second flushing, ink is immediately ejected from the recording heads 17a to 17c toward the paper P on the first transport belt 8. Therefore, the ejection failure of a non-ejecting nozzle may be improved at an early stage, and the non-ejecting nozzle may be restored as an ejecting nozzle at an early stage.

When the first flushing is performed in addition to the second flushing in S8, both the ejection to the paper P and the ejection to the opening portions 80 are performed, so that the non-ejecting nozzles is restored as an ejecting nozzle at an early stage.

In other words, according to the flushing control of the present embodiment, the recording heads 17a to 17c are made to execute appropriate flushing based on the presence or absence of a non-ejecting nozzle, and it is possible to improve deterioration of the image quality of the recorded image on the paper P or to improve the ejection failure of the non-ejecting nozzle at an early stage (early restoration).

Moreover, in a case where the control unit 110 determines that there is no non-ejecting nozzle based on the detection result of the ejection detection sensor 26 (NO in S3), the control unit 110, without causing the recording heads 17a to 17c to execute the second flushing, causes the recording heads 17a to 17c to execute the first flushing. By the first flushing, clogging of each ink ejection port 18 may be reduced or prevented. Furthermore, in the first flushing, the ink ejected from the recording heads 17a to 17c passes through the opening portions 80 of the first conveyor belt 8 and therefore does not adhere to the paper P on the first conveyor belt 8. As a result, deterioration of the image quality of the recorded image on the paper P may be avoided.

In addition, in a case where the control unit 110 determines that there is a non-ejecting nozzle based on the detection result of the ejection detection sensor 26 (YES in S3), the control unit 110 causes the recording heads 17a to 17c to execute the second flushing (S8). By the second flushing, at least clogging of the non-ejection ink ejection port 18 may be reduced or prevented. Furthermore, in the second flushing, the recording heads 17a to 17c immediately eject ink toward the paper P without waiting for specific opening groups 82 (opening portions 80) to come to the positions facing the recording heads 17a to 17c due to the traveling of the first conveyor belt 8. Therefore, the ejection failure of a non-ejecting nozzle may be improved at an early stage, and the non-ejecting nozzle may be restored as an ejecting nozzle at an early stage. In other words, it is possible to perform processing that prioritizes early restoration from a non-ejecting nozzle to an ejecting nozzle over image quality of the recorded image.

When the control unit 110 determines that there is a non-ejecting nozzle based on the detection result of the ejection detection sensor 26 (YES in S3), the control unit 110 may perform the first flushing in addition to the second flushing. By performing the first flushing as well, the possibility of restoring the non-ejecting nozzle to an ejecting nozzle can be further increased when the next ejection detection (S2) is performed.

Moreover, the control unit 110 causes the recording heads 17a to 17c to execute the second flushing of the non-ejecting nozzle as a target (S8). In this case, the number of ink ejection ports 18 for ejecting ink may be reduced as compared with a case in which ink is ejected from all of the ink ejection ports 18 onto the paper P to perform the second flushing. As a result, in the second flushing, the number of ink droplets that land on the recorded image on the paper P is reduced, and the effect on the image quality of the recorded image may be suppressed to a low level. In other words, the minimum necessary image quality of the recorded image may be ensured.

Moreover, before the control unit 110 selects either the first flushing of S5 (not the second flushing) or the second flushing of S8 and causes the recording heads 17a to 17c to execute, that is, before the control unit 110 selects either to perform the second flushing or not to perform the second flushing and causes the recording heads 17a to 17c to execute, the control unit 110 causes the recording heads 17a to 17c to execute oscillation of the ink meniscus in each ink ejection port 18 (S4, S7). This selection is based on the determination result of the presence or absence of the non-ejecting nozzle in S3. By causing the recording heads 17a to 17c to execute oscillation of the ink meniscus, it is possible to avoid an increase in the viscosity of the ink in the ink ejection ports 18. Therefore, by causing the recording heads 17a to 17c to perform the first flushing or the second flushing after that, it is possible to reduce or prevent nozzle clogging due to drying ink.

In addition, in a case where the control unit 110 determines that there is no non-ejecting nozzle based on the detection result of the ejection detection sensor 26 after causing the recording heads 17a to 17c to execute the second flushing, after that, causes the recording heads 17a to 17c to execute the first flushing (S8, S6, S2, S3, and S5). In a case where after performing the second flushing there is no non-ejecting nozzle, the flushing is returned to the first flushing which is not the second flushing, whereby it is possible to avoid the deterioration of the image quality of the recorded image by the first flushing while eliminating the concern that the image quality of the recorded image will be deteriorated by the second flushing.

Furthermore, the ejection detection sensor 26 described above is provided on the ink entry side of the ink receiving units 31Y to 31K (see FIG. 3). In this configuration, the internal space of the ink receiving units 31Y to 31K may be effectively used as the space for arranging the ejection detection sensors 26. Moreover, it is not necessary to secure an arrangement space for the ejection detection sensors 26 between the recording heads 17a to 17c and the first conveyor belt 8, so the recording heads 17a to 17c may be arranged close to the first conveyor belt 8, and thus the printer 100 may be made more compact.

Incidentally, in normal flushing in which the ink ejected from the nozzle passes through the opening portions in the conveyor belt, the ink does not adhere to the recording medium on the conveyor belt, so it is possible to avoid deterioration of the image quality of the image recorded on the recording medium. On the other hand, when there is a nozzle (also referred to as a non-ejecting nozzle) in which ink is not ejected occurs due to the progression of ink drying after performing normal flushing, it becomes impossible to record an image on a recording medium using the nozzle. In this case, it is desirable to perform another flushing for improving the ejection failure of the non-ejecting nozzle at an early stage. In other word, it is desirable to change the flushing method based on the presence or absence of a non-ejecting nozzle. However, control of such flushing has not yet been proposed, including in the above-mentioned typical techniques.

According to the configuration described above, it is possible to improve deterioration of the image quality of the recorded image or to improve the ejection failure of a non-ejecting nozzle at an early stage (early restoration) by causing the recording heads to execute appropriate flushing based on the presence or absence of a non-ejecting nozzle.

The present disclosure may be used in an inkjet recording apparatus that ejects ink onto a recording medium and records an image.

What is claimed is:

1. An inkjet recording apparatus comprising:
a recording head having a plurality of nozzles that eject ink;
a control unit that causes the recording head to execute flushing to eject the ink at a timing different from timing that contributes to image formation on a recording medium;
a continuous conveyor belt that has a plurality of opening portions through which the ink ejected from each nozzle of the recording head passes, and conveys the recording medium to a position facing the recording head; and
an ejection detection unit that detects the presence or absence of ejection of the ink from each nozzle; wherein
the flushing includes:
a first flushing that causes the recording head to eject the ink at a timing when the opening portions face the recording head due to traveling of the conveyor belt; and
a second flushing that causes the recording head to eject the ink at timing at which the recording medium on the conveyor belt faces the recording head due to traveling of the conveyor belt; and
the control unit, when causing the recording head to execute the first flushing, determines, based on a detection result of the ejection detection unit, the presence or absence of a non-ejecting nozzle in which the ink is not ejected, and based on the determination result of the presence or absence of the non-ejecting nozzle, selects either to perform the second flushing or not to perform the second flushing as subsequent flushing, and causes the recording head to execute flushing.

2. The inkjet recording apparatus according to claim 1, wherein
in a case where the control unit, based on a detection result of the ejection detection unit, determines there is no non-ejecting nozzle, causes the recording head to execute the first flushing as subsequent flushing without performing the second flushing.

3. The inkjet recording apparatus according to claim 1, wherein
the control unit, in a case where it is determined that there is a non-ejecting nozzle based on a detection result of the ejection detection unit, causes the recording head to execute the second flushing as subsequent flushing.

4. The inkjet recording apparatus according to claim 3, wherein
the control unit, in a case where it is determined that there is a non-ejecting nozzle based on a detection result of the ejection detection unit, causes the recording head to execute the first flushing as subsequent flushing.

5. The inkjet recording apparatus according to claim 1, wherein
the control unit causes the recording head to execute the second flushing on the non-ejecting nozzle.

6. The inkjet recording apparatus according to claim 1, wherein
the control unit selects either to perform the second flushing or not to perform the second flushing based on a determination result of the presence or absence of the non-ejecting nozzle, and causes the recording head to execute oscillation of the ink meniscus in each nozzle before causing the recording head to execute flushing.

7. The inkjet recording apparatus according to claim 1, wherein
the control unit, in a case where it is determined that there is no non-ejecting nozzle based on a detection result of the ejection detection unit after causing the recording head to execute the second flushing, causes the recording head to execute the first flushing after that.

8. The inkjet recording apparatus according to claim 1, further comprising
an ink receiving unit that receives the ink ejected from the recording head and passed through the opening portion of the conveyor belt when the recording head executes the first flushing; wherein
the ejection detection unit is provided on the ink entry side of the ink receiving unit.
